(19) United States
(12) Patent Application Publication
(10) Pub. No.: US 2011/0061604 A1
(43) Pub. Date: Mar. 17, 2011

(54) WHISTLING FETCH TOY

(76) Inventor: Justin G. Hill, Los Angeles, CA (US)

(21) Appl. No.: 12/882,160

(22) Filed: Sep. 14, 2010

Related U.S. Application Data
(60) Provisional application No. 61/241,991, filed on Sep. 14, 2009.

(51) Int. Cl. A01K 29/00; A01K 15/02

(52) U.S. Cl. 119/707

(57) ABSTRACT

A pet toy that makes whistling sounds when projected through the air.

### CLAIM OF PRIORITY

This application claims benefit of the filing date of U.S. Provisional Patent Application No. 61/241,991 as the priority date of this Non Provisional patent application.

### FIELD OF THE INVENTION

The present invention relates to the field of pet toys and amusement devices, and more specifically, to pet toy balls with sound devices.

### BACKGROUND OF THE INVENTION

The Labrador retriever is the most popular breed of dog in the world according to the American Kennel Club (AKC). It is estimated that in the United States as of 2005 there were some 298 million Labrador Retrievers in the country. There were also an estimated 130 million Labrador Retrievers throughout the rest of the world. In addition the AKC also recognizes six other retriever breeds. Labrador Retrievers have been bred to retrieve birds for over 200 years and are well known for their high energy temperament for play and work. Labrador Retrievers outnumber and other breed by almost twice as much in the US.

Considering the Labrador Retrievers breeding to retrieve birds, the retrieval instinct of the six other major breeds, and the hundreds of other breeds that have been bred as hunters, it makes sense that dogs would be attracted to a toy that seems like a bird.

Catering towards the hunting and retrieval instincts of most dogs, the present invention stimulates dogs by chirping through the air when thrown. Based on its unique design each time the ball is thrown, the present invention makes unique birdcalls to attract the dogs. Also non sound producing fetch toys are often thrown unbeknownst to the dog, which produces confusion as to where the toy was thrown. The present invention eliminates the “which way did it go” syndrome as dogs delight in tracking the sound of the present invention.

### SUMMARY OF THE INVENTION

The present invention is a pet toy with at least one passive sound device designed to create a sound when the toy is moved through the air. The pet toy is designed to be thrown through the air either by hand or by a compatible ball-throwing device. The quality of the sound created when thrown may be directly dependent on the quality of the throw. The sound device may be either attached to the exterior or the interior of the toy. The pet toy may be elongated, spherical, or any other shape.

There are several versions of the present invention each interchangeable variation of the following preferred embodiments. The present invention includes a plastic ball like toy containing whistles, and wing appendages. When the operator thrown the ball the wings flap and move about which creates more visual stimulus than an ordinary ball. Also when the operator throws the toy, air travels into a sound chamber, the air flowing into the sound chamber causes a vibration deviation which thereby produces sound. The preferred embodiment is responsive to the skill of the operator. The quality of the sound is dependent on the degree to which an operator can throw a toy.

A pet toy comprising a body portion being mostly spherical in shape, said body having a uniform diameter, said body portion having an outer surface and including at least one cavity opening through said outer surface, said cavity containing a closed inner end, the outer surface of said cavity being and opening having a reduced aperture therein, said cavity and said opening defining a sound chamber which is operable for receiving air therein in a turbulent motion so as to produce a whistling sound when said ball is moved through the air.

A pet toy comprising a body portion being mostly spherical in shape, said body having wing like appendages, said body having a uniform diameter, said body portion having an outer surface and including at least one cavity opening through said outer surface, said cavity containing a closed inner end, the outer surface of said cavity being and opening having a reduced aperture therein, said cavity and said opening defining a sound chamber which is operable for receiving air therein in a turbulent motion so as to produce a whistling sound when said ball is moved through the air.

The present invention proves and easy operating sound producing toy. The toy does not incorporate electrical devices to produce the sounds. Rather the toy operator causes the toy to produce the sounds when passing it through the air, such as when the operator throws the toy. Therefore, the toy is more dynamic than traditional balls.

### BRIEF DESCRIPTION OF THE DRAWINGS

FIG. 1 is a side view of the present invention with winged appendages.

FIG. 2 is a side view of the present invention without winged appendages.

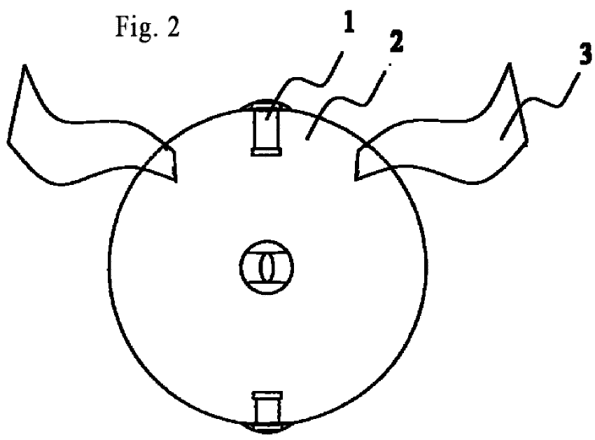

FIG. 3 is an exploded side view showing how the parts can be put together.

### DETAILED DESCRIPTION OF PREFERRED EMBODIMENTS

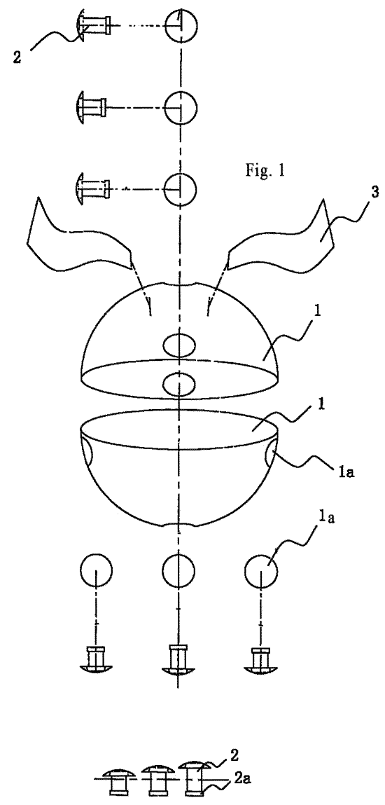

The present invention may be created by those skilled in the arts of making pet toys or balls. FIG. 1 shows an exploded side view of present invention with wings. The core of the ball (1) can be created out a large number of materials but is preferably a plastic or rubber polymer. The whistles or sound producing devices (2) can also be created out of a large number of materials but also are preferably made of a plastic or rubber polymer. The core can be created via injection moulding with holes (1a) sized to be appropriately pressure fit with the size of the sound devices (2). The sound producing devices (2) can also be created in two pieces (2a) that can be joined together around the core (1) like a bolt and a nut, although the sound devices (2) can also be glued together around the core (1) or joined via a welding technique, thus securing the sound devices (2) to the core (1). The passive sound device (2) is not augmented by electronic components, but rather takes advantage of the airflow around the outer surface of the toy to produce the sound. The airflow around the toy is related to the speed with which the toy is propelled through the air. Additionally, the rotation of the toy impacts the speed of the airflow around the toy. As the speed of the toy, frequency of rotations or both increases the speed of the airflow around the toy increases. The passive sound device uses the airflow around the toy for the production of the sound.

The passive sound device (2) designed to create sound when the toy is thrown through the air can be joined to the interior or the exterior of the toy in a variety of ways. To name a few, the passive sound device designed to create noise when the toy is thrown may be integral with the toy body portion simply by moulding the toy body portion around the sound device. The same sound device may also be attached to the body with an adhesive. The sound device (2) can be embedded in the toy and shaped in such a way that the hole through the body of the toy in which the head of the sound device passes, is too small for the body or the head of the device to pass through, thus preventing it from separating from the toy.

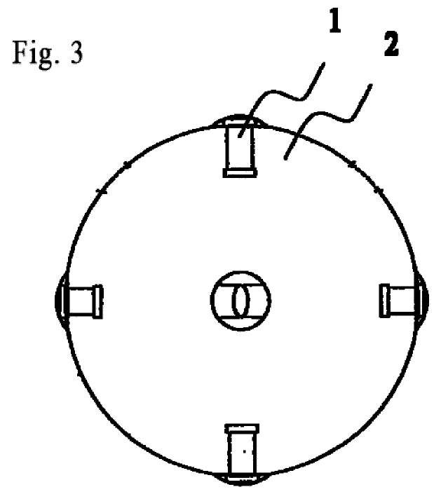

The winged appendages on the pet toy (3) are preferably a durable cloth and can either be attached to the toy with an adhesive or by a mechanical means such as by creating a mass on the wing on the inside of the core, such as a knot, larger than the opening in the core. The wings (3) can be a variety of shapes which all have different properties of flight or rotation and flappiness. The present invention without the wings as in FIG. 3 also has the advantage of better aerodynamics. Although the present invention has been described with reference to preferred embodiments, workers skilled in the art will recognize that changes may be made in form and detail without departing from the spirit and scope of the invention.

What is claimed:

1. A pet toy comprising a body portion being mostly spherical in shape, said body having a uniform diameter, said body portion having an outer surface and including at least one cavity opening through said outer surface, said cavity containing a closed inner end, the outer surface of said cavity being and opening having a reduced aperture therein, said cavity and said opening defining a sound chamber which is operable for receiving air therein in a turbulent motion so as to produce a whistling sound when said ball is moved through the air

2. The pet toy of claim 1, said cavity and opening being located anywhere on the toy and in any quantity.

3. The pet toy of claim 1, said cavity being cylindrical in shape.

4. The pet toy of claim 1, said aperture being substantially rectangular in shape.

5. The pet toy of claim 1, said cavity being preferably disposed in perpendicular relation to axis of rotation.

6. The pet toy of claim 1, said opening comprising a pliable and resilient material.

7. A pet toy comprising a body portion being mostly spherical in shape, said body having wing like appendages, said body having a uniform diameter, said body portion having an outer surface and including at least one cavity opening through said outer surface, said cavity containing a closed inner end, the outer surface of said cavity being and opening having a reduced aperture therein, said cavity and said opening defining a sound chamber which is operable for receiving air therein in a turbulent motion so as to produce a whistling sound when said ball is moved through the air.

8. The pet toy of claim 7, said cavity and opening being located anywhere on the toy and in any quantity.

9. The pet toy of claim 7, said cavity being cylindrical in shape.

10. The pet toy of claim 7, said aperture being substantially rectangular in shape.

11. The pet toy of claim 7, said cavity being preferably disposed in perpendicular relation to axis of rotation.

12. The pet toy of claim 7, said opening comprising a pliable and resilient material.

13. The pet toy of claim 7, said appendages being preferably a durable cloth material.
